(19) United States
(12) Patent Application Publication
(10) Pub. No.: US 2026/0111002 A1
(43) Pub. Date: Apr. 23, 2026

(54) SYSTEMS. APPARATUSES, METHODS, AND COMPUTER PROGRAM PRODUCTS FOR PEAK PREDICTION

(71) Applicant: Honeywell International Inc., Charlotte, NC (US)

(72) Inventors: Junda ZHU, Atlanta, GA (US); Sahil VARTAK, Atlanta, GA (US); Tarun MIRANI, Woodstock, GA (US); Sabina AZIZLI, Houston, TX (US); Aishwarya Coffey, Dublin (IE); Rakesh VENUTURUMILLI, Phoenix, AZ (US)

(21) Appl. No.: 18/924,085

(22) Filed: Oct. 23, 2024

(51) Int. Cl. G05B 19/406

(52) U.S. Cl. CPC G05B 19/406; G05B 2219/40163

(57) ABSTRACT

Systems, apparatuses, methods, and computer program products are provided herein. For example, a method may include identifying historical flaring data representing flaring associated with one or more plants. In some embodiments, the method includes identifying historical plant component operations data representing historical operations of one or more components of the one or more plants. In some embodiments, the method includes configuring a flare peak prediction model using the historical flaring data and the historical plant component operations data. In some embodiments, the method includes receiving real-time plant operations data representing real-time operations of a first plant of the one or more plants. In some embodiments, the method includes generating flare peak prediction data by applying the real-time plant operations data to the flare peak prediction model. In some embodiments, the method includes initiating performance of one or more flare peak prediction responsive actions based on the flare peak prediction data.

### TECHNOLOGICAL FIELD

Embodiments of the present disclosure relate generally to systems, apparatuses, methods, and computer program products for initiating performance of one or more flare peak prediction responsive actions, such as related to flare peak prediction.

### BACKGROUND

Applicant has identified many technical challenges and difficulties associated with systems, apparatuses, methods, and computer program products for managing flaring at a processing plant. Through applied effort, ingenuity, and innovation, Applicant has solved problems related to systems, apparatuses, methods, and computer program products managing flaring at a processing plant by developing solutions embodied in the present disclosure, which are described in detail below.

### BRIEF SUMMARY

Various embodiments described herein relate to systems, apparatuses, methods, and computer program products for initiating performance of one or more flare peak prediction responsive actions.

In accordance with one aspect of the disclosure a method is provided. In some embodiments, the method includes identifying historical flaring data representing flaring associated with one or more plants. In some embodiments, the historical flaring data is associated with a first time period. In some embodiments, the method includes identifying historical plant component operations data representing historical operations of one or more components of the one or more plants. In some embodiments, the historical plant component operations data is associated with the first time period. In some embodiments, the method includes configuring a flare peak prediction model using the historical flaring data and the historical plant component operations data. In some embodiments, the method includes receiving real-time plant operations data representing real-time operations of a first plant of the one or more plants. In some embodiments, the method includes generating flare peak prediction data by applying the real-time plant operations data to the flare peak prediction model. In some embodiments, the method includes initiating performance of one or more flare peak prediction responsive actions based on the flare peak prediction data.

In some embodiments, the method includes processing the historical flaring data and the historical plant component operations data by performing a labeling technique.

In some embodiments, configuring the flare peak prediction model comprises determining one or more flare peaks associated with the one or more plants that occurred during the first time period by performing at least one of a plurality of peak prediction operations using the historical flaring data using the historical flaring data.

In some embodiments, configuring the flare peak prediction model comprises generating flare peak signature data based on the one or more flare peaks and the historical plant component operations data.

In some embodiments, configuring the flare peak prediction model comprises training the flare peak prediction model using the flare peak signature data.

In some embodiments, a first peak prediction operation of the plurality of peak prediction operations comprises performing a binary classification technique using the historical flaring data.

In some embodiments, a second peak prediction operation of the plurality of peak prediction operations comprises performing a multiclass classification technique using the historical flaring data.

In some embodiments, a third peak prediction operation of the plurality of peak prediction operations comprises determining a predicted flaring rate by performing a regression technique using the historical flaring data.

In some embodiments, a third peak prediction operation of the plurality of peak prediction operations comprises performing one or more optimization techniques using the predicted flaring rate.

In some embodiments, a fourth peak prediction operation of the plurality of peak prediction operations comprises determining a predicted flaring rate by performing a multivariate time series forecasting technique using the historical flaring data.

In some embodiments, a fourth peak prediction operation of the plurality of peak prediction operations comprises performing one or more optimization techniques using the predicted flaring rate.

In some embodiments, initiating performance of the one or more flare peak prediction responsive actions comprises a flare peak prediction interface component.

In some embodiments, the flare peak prediction interface component comprises the flare peak prediction data.

In some embodiments, initiating performance of the one or more flare peak prediction responsive actions comprises causing the flare peak prediction interface component to be rendered to a flare peak prediction interface of a computing device.

In some embodiments, initiating performance of the one or more flare peak prediction responsive actions comprises causing actuation of at least one of the one or more components of the first plant.

In some embodiments, initiating performance of the one or more flare peak prediction responsive actions comprises transmitting a flare peak prevention action instruction to the first plant.

In accordance with another aspect of the disclosure, an apparatus is provided. In some embodiments, the apparatus includes memory and one or more processors communicatively coupled to the memory. In some embodiments, the one or more processors are configured to identify historical flaring data representing flaring associated with one or more plants. In some embodiments, the historical flaring data is associated with a first time period. In some embodiments, the one or more processors are configured to identify historical plant component operations data representing historical operations of one or more components of the one or more plants. In some embodiments, the historical plant component operations data is associated with the first time period. In some embodiments, the one or more processors are configured to configure a flare peak prediction model using the historical flaring data and the historical plant component operations data. In some embodiments, the one or more processors are configured to receive real-time plant operations data representing real-time operations of a first plant of the one or more plants. In some embodiments, the one or more processors are configured to generate flare peak prediction data by applying the real-time plant operations data to the flare peak prediction model. In some embodiments, the one or more processors are configured to initiate performance of one or more flare peak prediction responsive actions based on the flare peak prediction data.

In some embodiments, to configure the flare peak prediction model comprises the one or more processors being configured to determine one or more flare peaks associated with the one or more plants that occurred during the first time period by performing at least one of a plurality of peak prediction operations using the historical flaring data using the historical flaring data.

In some embodiments, to configure the flare peak prediction model comprises the one or more processors being configured to generate flare peak signature data based on the one or more flare peaks and the historical plant component operations data.

In some embodiments, to configure the flare peak prediction model comprises the one or more processors being configured to train the flare peak prediction model using the flare peak signature data.

In some embodiments, a first peak prediction operation of the plurality of peak prediction operations comprises the one or more processors being configured to perform a binary classification technique using the historical flaring data.

In some embodiments, a second peak prediction operation of the plurality of peak prediction operations comprises the one or more processors being configured to perform a multiclass classification technique using the historical flaring data.

In some embodiments, a third peak prediction operation of the plurality of peak prediction operations comprises the one or more processors being configured to determine a predicted flaring rate by performing a regression technique using the historical flaring data.

In some embodiments, a third peak prediction operation of the plurality of peak prediction operations comprises the one or more processors being configured to perform one or more optimization techniques using the predicted flaring rate.

In some embodiments, a fourth peak prediction operation of the plurality of peak prediction operations comprises the one or more processors being configured to determine a predicted flaring rate by performing a multivariate time series forecasting technique using the historical flaring data.

In some embodiments, a fourth peak prediction operation of the plurality of peak prediction operations comprises the one or more processors being configured to performing one or more optimization techniques using the predicted flaring rate.

In some embodiments, to initiate performance of the one or more flare peak prediction responsive actions comprises the one or more processors being configured to generate a flare peak prediction interface component.

In some embodiments, the flare peak prediction interface component comprises the flare peak prediction data.

In some embodiments, to initiate performance of the one or more flare peak prediction responsive actions comprises the one or more processors being configured to cause the flare peak prediction interface component to be rendered to a flare peak prediction interface of a computing device.

In some embodiments, to initiate performance of the one or more flare peak prediction responsive actions comprises the one or more processors being configured to cause actuation of at least one of the one or more components of the first plant.

In some embodiments, to initiate performance of the one or more flare peak prediction responsive actions comprises the one or more processors being configured to transmit a flare peak prevention action instruction to the first plant.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for identifying historical flaring data representing flaring associated with one or more plants. In some embodiments, the historical flaring data is associated with a first time period. In some embodiments, the computer program code, in execution with at least one processor, configures the computer program product for identifying historical plant component operations data representing historical operations of one or more components of the one or more plants. In some embodiments, the historical plant component operations data is associated with the first time period. In some embodiments, the computer program code, in execution with at least one processor, configures the computer program product for configuring a flare peak prediction model using the historical flaring data and the historical plant component operations data. In some embodiments, the computer program code, in execution with at least one processor, configures the computer program product for receiving real-time plant operations data representing real-time operations of a first plant of the one or more plants. In some embodiments, the computer program code, in execution with at least one processor, configures the computer program product for generating flare peak prediction data by applying the real-time plant operations data to the flare peak prediction model. In some embodiments, the computer program code, in execution with at least one processor, configures the computer program product for initiating performance of one or more flare peak prediction responsive actions based on the flare peak prediction data.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates an interface in accordance with one or more embodiments of the present disclosure;

FIG. 4 illustrates a flowchart of an example method in accordance with one or more embodiments of the present disclosure;

FIG. 5 illustrates a flowchart of an example method in accordance with one or more embodiments of the present disclosure;

FIG. 6 illustrates a flowchart of an example method in accordance with one or more embodiments of the present disclosure; and

FIG. 7 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with managing flaring at a processing plant. As would be understood by one skilled in the field to which this disclosure pertains, there are numerous example scenarios in which managing flaring at a processing plant is desirable. For example, it may be desirable to manage flaring at a processing plant, such as a hydrocarbon processing plant, by predicting flare peaks in order to quantify the amount of emissions (e.g., greenhouse gases), the processing plant is releasing into a surrounding environment. In this way, the processing plant and/or an entity associated with the processing plant can ensure that they are complying with government regulations and are on track to meet their net zero goals. As another example, it may be desirable to manage flaring at a processing plant by predicting flare peaks in order to prevent and/or mitigate flare peaks. In this way, the processing plant and/or an entity associated with the processing plant can reduce their emissions by preventing and/or mitigating flare peaks.

Example solutions for managing flaring at a processing plant include using a computing device to manage the flaring associated with the processing plant. For example, such example solutions may use a computing device to quantify the amount of emissions the processing plant is releasing into a surrounding environment through flaring. However, such example solutions are inefficient, reactive, simplistic, and technically deficient. For example, such example solutions are inefficient because such example solutions do not use a specifically configured flare peak prediction system for managing flaring at a processing plant. As a result, such example solutions cause computing devices to suffer from high latency, consume excessive processing power, and consume excessive memory. As another example, such example solutions are reactive because such example solutions are unable to automatically implement flare peak prediction responsive actions that include causing actuation of one or more components at a processing plant and/or transmitting a flare peak prevention action instruction. As another example, such example solutions are simplistic because such example solutions are unable to configure a flare peak prediction model based on at least one of a plurality of peak prediction operations. As another example, such example solutions are technically deficient because such example solutions are unable to predict flare peaks at a processing plant before they happen. As a result, such example solutions are limited to monitoring flare peaks as they occur and are unable to implement actions to prevent or mitigate the flare peaks. Accordingly, there is a need there is a need for systems, apparatuses, methods, and computer program products that are able manage flaring at a processing plant in an efficient, a proactive, a sophisticated, and a technically sufficient manner.

Thus, to address these and/or other issues related to such example solutions, example systems, apparatuses, methods, and computer program products for initiating performance of one or more flare peak prediction responsive actions are provided herein. For example, an embodiment in this disclosure, described in greater details below, includes a method that includes identifying historical flaring data representing flaring associated with one or more plants. In some embodiments, the historical flaring data is associated with a first time period. In some embodiments, the method includes identifying historical plant component operations data representing historical operations of one or more components of the one or more plants. In some embodiments, the historical plant component operations data is associated with the first time period. In some embodiments, the method includes configuring a flare peak prediction model using the historical flaring data and the historical plant component operations data. In some embodiments, the method includes receiving real-time plant operations data representing real-time operations of a first plant of the one or more plants. In some embodiments, the method includes generating flare peak prediction data by applying the real-time plant operations data to the flare peak prediction model. In some embodiments, the method includes initiating performance of one or more flare peak prediction responsive actions based on the flare peak prediction data. Accordingly, the systems, apparatuses, methods, and computer program products provided herein enable managing flaring at a processing plant in an efficient, a proactive, a sophisticated, and a technically sufficient manner.

### Example Systems and Apparatuses

Embodiments of the present disclosure herein include systems, apparatuses, methods, and computer program products configured for initiating performance of one or more flare peak prediction responsive actions, such as related to peak prediction. It should be readily appreciated that the embodiments of the apparatus, systems, methods, and computer program product described herein may be configured in various additional and alternative manners in addition to those expressly described herein.

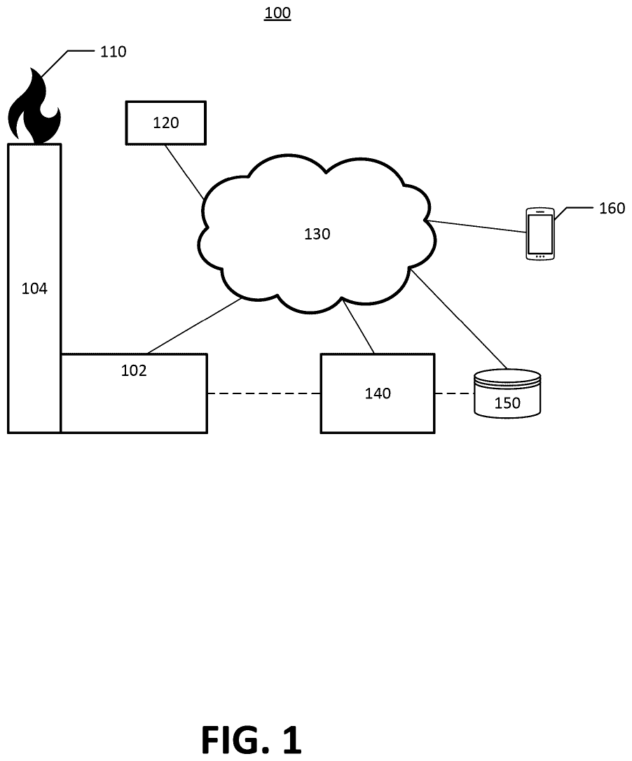

FIG. 1 illustrates an exemplary block diagram of an environment in which embodiments of the present disclosure may operate. Specifically, FIG. 1 illustrates one or more plants 102. In some embodiments, for example, the one or more plants 102 may be any type of plant associated with a user associated with the environment 100. In this regard, the one or more plants 102 may, for example, be a processing plant that receives and processes input ingredients to create a processed product, such as a hydrocarbon processing plant, a refinery, a pulp and paper plant, a chemical plant, an alumina plant, a drilling facility, a fracking field, and/or the like. In some embodiments, the one or more plants 102 may include a first plant.

In some embodiments, each of the one or more plants 102 includes any number of individual processing components. The components may perform a particular function during operation of the one or more plants 102. For example, the components may include one or more well components, fracking components, crude processing components (e.g., crude processing components having a vacuum section), hydrotreating components, isomerization components, reforming components, vapor recovery components, fluid catalytic cracking components, batch blending components, rundown blending components, hydrocracking components, alkylation components, dewaxing components, deasphalter components (e.g., propane deasphalter components), aromatics reduction components, delayed cooker components, visbreaker components, digester components, valve components, thermomechanical grinding components, bleaching components, blender components, pump components, flash venting components, compressor components, cooler components (e.g., air cooler components), sensor components, flare components, heating, ventilation, and air (HVAC) components, interface components, lighting components, and/or the like that perform a particular operation for transforming, separating, reacting, reforming, digesting, bleaching, storing, releasing, and/or otherwise handling one or more input ingredients, intermediate ingredients, and/or processed products (e.g., hydrocarbons, gases, etc.). In this regard, for example, the individual components of the one or more plants 102 may include components associated with a particular process performed by the one or more plants 102.

In some embodiments, each of the one or more plants 102 are associated with a flare stack 104. The flare stack 104 may be used to flare and/or vent one or more gases. These gases may include, but are not limited to, greenhouse gases. Flaring of gases may generate a flare 110. The flare 110 may be associated with flaring. Flaring involves the igniting and burning of concentrations of flammable gases. A gas may be comprised of a plurality of concentrations of individual gases, and some of these concentrations of individual gases may be flammable. Alternatively, a gas may be comprised of a concentration of an individual gas, which may or may not be flammable. In some embodiments, a gas may contain greenhouse gases, such as hydrocarbons. The hydrocarbons may be ignited by an ignition source, such as a pilot flame, when the gas passes by the ignition source. The ignited gas(es) may be referred to as flares, and this process may be referred to as flaring. In various embodiments, flaring may occur at the flare stack 104, which may be at a high level of elevation from one or more other components of the one or more plants 102, process area, piping, and the like associated with a site.

In embodiments with gases comprising hydrocarbons, the flaring of hydrocarbons will include lower emissions than the venting of the same gas(es). This is because flaring converts the hydrocarbons in the gas(es) to CO2 and water while venting does not change the composition of the waste gas to water. Thus, the flaring may reduce the emissions of hydrocarbons into the atmosphere. In contrast to flaring, venting does not use combustion and, instead, is a direct release of gas(es) to the atmosphere. While FIG. 1 illustrates a flare 110, it will also be appreciated that by removing or omitting an ignition source, such as a pilot flame, gas(es) may be vented without flaring.

The flare 110 of the flare stack 104 may be observed, measured, analyzed by, and/or the like by one or more sensors 120 in accordance with operations and/or functions described herein. The one or more sensors 120 may generate and/or transmit sensor data across a network 130 to a flare peak prediction system 140. The flare peak prediction system 140 may be electronically and/or communicatively coupled to the one or more plants 102 (e.g., including the first plant), one or more databases 150, and the user device 160. In some embodiments, the one or more plants 102 include at least one plant that is different type of processing plant, and/or does not include the flare stack 104.

The one or more sensors 120 may include sensors to detect, measure, and/or analyze data associated with operation of the one or more plants 102, for example the first plant. In one such example context, the sensors detect, measure, and/or analyze a flare 110 and/or a gas emission, for example associated with a flaring and/or a venting. In some embodiments, the one or more sensors 120 may include a camera, which may be configured to capture images and/or video in one or more spectrums of light. For example, a camera may be configured to capture images and/or video in the visible spectrum. Additional, and/or alternatively, a camera may be configured to capture images and/or video in the infrared spectrum. It will be appreciated that any number of sensor(s), sensor type(s), and/or the like may be utilized to monitor operations of the one or more plants 102.

In some embodiments, the one or more sensors 120 (e.g., a camera) may be configured to perform or execute one or more operations and/or functions with determining a type, quantity, and/or volume of gas flared and/or emitted. For example, a camera may capture both visible light and infrared light to generate images and/or video of flaring. Based on these images and/or video of flaring, the camera may determine a type of gas being in a flare 110 as well as a volume of gas flared. In another example with a gas emission that is vented and not flared, a camera may capture both visible light and infrared light to generate images and/or video of venting. Based on these images and/or video of venting, the camera may determine a type of gas being in a flare 110 as well as a volume of gas flared. In various embodiments, the one or more sensors 120 may generate sensor data (e.g., a camera generating images and/or video) and transmit the sensor data over a network 130.

In some embodiments, each individual component of the one or more plants 102 is associated with a determinable location. The determinable location of a particular component in some embodiments represents an absolute position (e.g., GPS coordinates, latitude and longitude locations, and/or the like) or a relative position (e.g., a point representation of the location of a component from a local origin point corresponding to the one or more plants 102). In some embodiments, a component includes or otherwise is associated with a location sensor and/or software-driven location services that provide the location data representing the location corresponding to that component. In other embodiments the location of a component is stored and/or otherwise predetermined within a software environment, provided by a user and/or otherwise determinable to one or more systems, for example including the flare peak prediction system 140.

Additionally, or alternatively, in some embodiments, each of the one or more plants 102 itself is associated with a determinable location. The determinable location of each of the one or more plants 102 in some embodiments represents an absolute position (e.g., GPS coordinates, latitude and longitude locations, an address, and/or the like) or a relative position of the one or more plants 102 (e.g., an identifier representing the location of each of the one or more plants 102 as compared to one or more other plants, an enterprise headquarters, or general description in the world for example based at least in part on continent, state, or other definable region). In some embodiments, the one or more plants 102 include or otherwise is associated with a location sensor and/or software-driven location services that provide the location data corresponding each of to the one or more plants 102. In other embodiments, the location of each of the one or more plants 102 is stored and/or otherwise determinable to one or more systems, for example including the flare peak prediction system 140.

The network 130 may be embodied in any of a myriad of network configurations. In some embodiments, the network 130 may be a public network (e.g., the Internet). In some embodiments, the network 130 may be a private a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

The flare peak prediction system 140 may be located remotely or in proximity of a particular plant, for example the one or more plants 102. In this regard, in some embodiments, the flare peak prediction system 140 may be located remotely or in proximity to the emissions sources, such as flare 110. In some embodiments, the flare peak prediction system 140 is configured via hardware, software, firmware, and/or a combination thereof, to perform data intake of one or more types of data associated with the one or more plants 102, for example the first plant. Additionally, or alternatively, in some embodiments, the flare peak prediction system 140 is configured via hardware, software, firmware, and/or a combination thereof, to generate and/or transmit command(s) that control, adjust, or otherwise impact operations of a particular plant or specific component(s) thereof, for example for controlling one or more operations of the one or more plants 102. Additionally or alternatively still, in some embodiments, the flare peak prediction system 140 is configured via hardware, software, firmware, and/or a combination thereof, to perform data reporting and/or other data output process(es) associated with monitoring or otherwise analyzing operations of the one or more plants 102, for example for generating and/or outputting report(s) corresponding to the operations performed via the one or more plants 102. For example, in various embodiments, the flare peak prediction system 140 may be configured to execute and/or perform one or more operations and/or functions described herein.

The one or more databases 150 may be configured to receive, store, and/or transmit data. In various embodiments, the one or more databases 150 may be associated with data received from the one or more sensors 120. Additionally, or alternatively, in some embodiments the one or more databases 150 store user inputted data associated with operations of the one or more plants 102. Additionally, or alternatively, the one or more databases 150 may be associated with data received form one or more other sources outside the environment 100.

The user device 160 may be associated with users of the flare peak prediction system 140. In various embodiments, the flare peak prediction system 140 may generate and/or transmit a message, alert, or indication to a user via a user device 160. Additionally, or alternatively, a user device 160 may be utilized by a user to remotely access a flare peak prediction system 140. This may be by, for example, an application operating on the user device 160. A user may access the flare peak prediction system 140 remotely, including one or more visualizations, reports, and/or real-time displays.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the flare peak prediction system 140 may include one or more databases 150, which may collectively be located in or at the one or more plants 102.

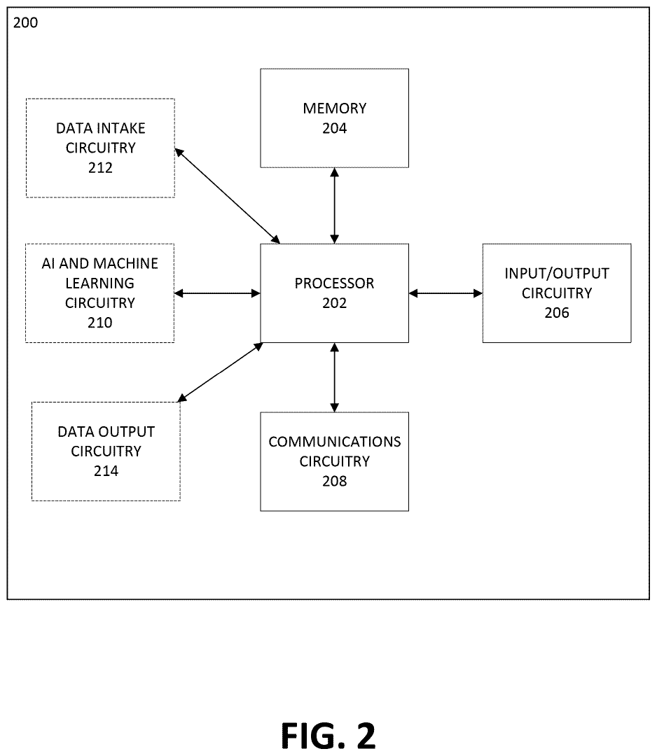

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. Examples of an apparatus 200 may include, but is not limited to, the one or more sensors 120, the flare peak prediction system 140, the one or more databases 150, and/or the user device 160. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as an computing apparatus 200 of a flare peak prediction system 140 or of the user device 160 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the one or more plants 102. In some embodiments, the data intake circuitry 212 includes hardware, software, firmware, and/or a combination thereof, that communicates with one or more sensor(s), component(s), and/or the like within a particular plant to receive particular data associated with such operations of the one or more plants 102. The data intake circuitry 212 may support such operations for any number of individual plants. Additionally, or alternatively, in some embodiments, the data intake circuitry 212 includes hardware, software, firmware, and/or a combination thereof, that retrieves particular data associated with one the one or more plants 102 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured to facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect the AI and machine learning circuitry 210.

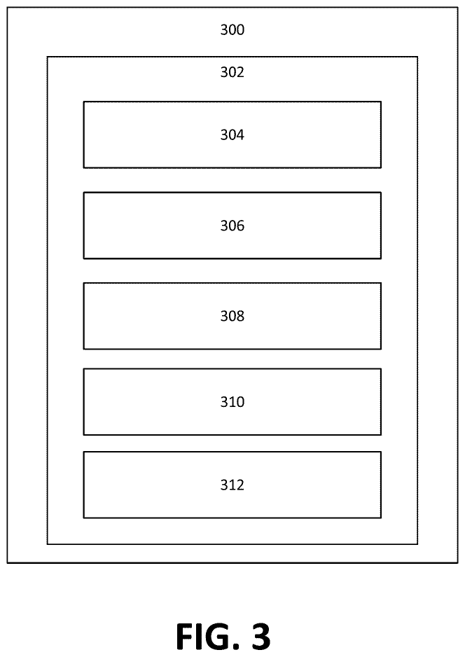

With reference to FIGS. 1-3, in some embodiments, the flare peak prediction system 140 is configured to identify historical flaring data. In some embodiments, historical flaring data includes one or more items of data representative of historical flaring performed by the one or more plants 102. In some embodiments, historical flaring data is associated with a first time period. In some embodiments, the first time period is a timeboxed period, time interval, and/or unit of time that previously occurred (e.g., a period of time that has elapsed, a historical period of time, etc.). In this regard, for example, historical flaring data may be representative and/or indicative of a historical rate of flaring performed by the one or more plants 102 in the first time period. As another example, historical flaring data may be representative and/or indicative of an amount of flaring in the first time period (e.g., the total amount of flaring performed in the first time period). As another example, historical flaring data may be representative and/or indicative of a duration of flaring in the first time period (e.g., how long flaring events in the first time period lasted). As another example, historical flaring data may be representative and/or indicative of content of flaring in the first time period (e.g., what types of gases were released and/or burned during the flaring). As another example, historical flaring data may be representative and/or indicative of one or more flare peaks in the first time period.

In some embodiments, a flare peak is representative and/or indicative of a temporary increase in flaring performed by the one or more plants 102 relative to a baseline flaring rate (e.g., an increase in a rate or an amount of flaring). For example, if the one or more plants 102 are flaring at a rate of one thousand cubic feet per day, a flare peak may be when the flaring rate is at ten thousand cubic feet per day. In this regard, for example, historical flaring data may be representative and/or indicative of content of a flare peak that occurred in the first time period (e.g., what types of gases were released and/or burned during a flare peak). As another example, historical flaring data may be representative and/or indicative of a duration of a flare peak that occurred in the first time period. As another example, historical flaring data be representative and/or indicative of the start of a flare peak that occurred in the first time period. As another example, historical flaring data be representative and/or indicative of the middle of a flare peak that occurred in the first time period (e.g., a halfway point of the flare peak). As another example, historical flaring data be representative and/or indicative of the end of a flare peak that occurred in the first time period. As another example, historical flaring data may be representative and/or indicative of an amount above a baseline flaring rate that a flare peak was during the first time period.

In some embodiments, identifying historical flaring data includes the flare peak prediction system 140 being configured to receive historical flaring data. For example, the flare peak prediction system 140 may be configured to receive historical flaring data from the one or more plants 102 (e.g., such as the first plant in the one or more plants 102), the user device 160, and/or the one or more sensors 120. In some embodiments, prior to receiving historical flaring data, the flare peak prediction system 140 is configured to cause the one or more plants 102 and/or the one or more sensors 120 to generate and/or capture historical flaring data. Additionally, or alternatively, identifying historical flaring data includes the flare peak prediction system 140 being configured to generate historical flaring data. For example, the flare peak prediction system 140 may be configured to generate historical flaring data using other data associated with the one or more plants 102. In this regard, for example, the flare peak prediction system 140 may be configured to generate historical flaring data using historical plant component operations data associated with the one or more plants 102. Additionally, or alternatively, identifying historical flaring data may include the flare peak prediction system 140 being configured to generate at least a portion of historical flaring data. For example, the flare peak prediction system 140 may be configured to receive a first portion of historical flaring data and, using the first portion, generate a second portion of historical flaring data (e.g., using interpolation).

In some embodiments, the flare peak prediction system 140 is configured to identify historical plant component operations data. In some embodiments, historical plant component operations data is associated with the first time period. In some embodiments, historical plant component operations data includes one or more items of data representative and/or indicative of historical operations of one or more components of the one or more plants 102. For example, historical plant component operations data may be representative and/or indicative of historical operations of one or more valve components that are associated with the one or more plants 102 (e.g., during the first time period).

In some embodiments, identifying historical plant component operations data includes the flare peak prediction system 140 being configured to receive historical plant component operations data. For example, the flare peak prediction system 140 may be configured to receive historical plant component operations data from the one or more plants 102 (e.g., such as the first plant in the one or more plants 102), the user device 160, and/or the one or more sensors 120. In some embodiments, prior to receiving historical plant component operations data, the flare peak prediction system 140 is configured to cause the one or more plants 102 and/or the one or more sensors 120 to generate and/or capture historical plant component operations data. Additionally, or alternatively, identifying historical plant component operations data includes the flare peak prediction system 140 being configured to generate historical plant component operations data. For example, the flare peak prediction system 140 may be configured to generate historical plant component operations data using other data associated with the one or more plants 102. In this regard, for example, the flare peak prediction system 140 may be configured to generate historical plant component operations data using historical flaring data associated with the one or more plants 102. Additionally, or alternatively, identifying historical plant component operations data may include the flare peak prediction system 140 being configured to generate at least a portion of historical plant component operations data. For example, the flare peak prediction system 140 may be configured to receive a first portion of historical plant component operations data and, using the first portion, generate a second portion of historical plant component operations data (e.g., using interpolation).

In some embodiments, the flare peak prediction system 140 is configured to process historical flaring data. In some embodiments, processing historical flaring data includes performing a labeling technique. In this regard, for example, processing historical flaring data by performing a labeling technique includes the flare peak prediction system 140 being configured to tag historical flaring data with one or more information labels that describe historical flaring data. In some embodiments, the flare peak prediction system 140 is configured to process historical plant component operations data. In some embodiments, processing historical plant component operations data includes performing a labeling technique. In this regard, for example, processing historical plant component operations data by performing a labeling technique includes the flare peak prediction system 140 being configured to tag historical plant component operations data with one or more information labels that describe historical plant component operations data.

In some embodiments, the flare peak prediction system 140 is configured to configure a flare peak prediction model. In some embodiments, the flare peak prediction system 140 is configured to configure the flare peak prediction model using historical flaring data (e.g., using historical flaring data identified by the flare peak prediction system 140). Additionally, or alternatively, the flare peak prediction system 140 is configured to configure the flare peak prediction model using historical plant component operations data (e.g., using historical plant component operations data identified by the flare peak prediction system 140).

In some embodiments, configuring the flare peak prediction model includes the flare peak prediction system 140 being configured to determine one or more flare peaks associated with the one or more plants 102 during the first time period. In some embodiments, the flare peak prediction system 140 is configured to determine one or more flare peaks associated with the one or more plants 102 during the first time period by performing at least one of a plurality of peak prediction operations. In some embodiments, the flare peak prediction system 140 is configured to performing at least one of a plurality of peak prediction operations using historical flaring data. In this regard, for example, the flare peak prediction system 140 may be configured to determine one or more flare peaks that occurred at the one or more plants 102 during the first time period (e.g., the time period associated with historical flaring data identified by the flare peak prediction system 140 and/or historical operations data). Said differently, for example, the flare peak prediction system 140 may be configured to perform multiple different operations and/or techniques to determine one or more flare peaks.

In some embodiments, the plurality of peak prediction operations includes a first peak prediction operation. In some embodiments, the first peak prediction operation includes the flare peak prediction system 140 being configured to perform a binary classification technique using historical flaring data. In some embodiments, a binary classification technique includes the flare peak prediction system 140 being configured to use historical flaring data that is representative and/or indicative of a rate of flaring to determine whether there is a flare peak associated with the one or more plants 102 (e.g., yes, there is a flare peak) that occurred in the first time period. Additionally, or alternatively, a binary classification technique includes the flare peak prediction system 140 being configured to use historical flaring data that is representative and/or indicative of a rate of flaring to determine whether there is not a flare peak associated with the one or more plants 102 that occurred in the first time period (e.g., no, there is not a flare peak). Said differently, for example, performing the first peak prediction operation includes flare peak prediction system 140 being configured to perform a binary classification technique to determine one or more flare peaks associated with the one or more plants 102 that occurred during the first time period by determining whether there is a flare peak or whether there is not a flare peak (e.g. using historical flaring data representative of a rate of flaring).

In some embodiments, the plurality of peak prediction operations includes a second peak prediction operation. In some embodiments, the second peak prediction operation includes the flare peak prediction system 140 being configured to perform a multiclass classification technique using historical flaring data. In some embodiments, a multiclass classification technique includes the flare peak prediction system 140 being configured to use historical flaring data that is representative and/or indicative of a rate of flaring to determine a start of a flare peak associated with the one or more plants 102 that occurred in the first time period. Additionally, or alternatively, a multiclass classification technique includes the flare peak prediction system 140 being configured to use historical flaring data that is representative and/or indicative of a rate of flaring to determine a middle of a flare peak associated with the one or more plants 102 that occurred in the first time period. Additionally, or alternatively, a multiclass classification technique includes the flare peak prediction system 140 being configured to use historical flaring data that is representative and/or indicative of a rate of flaring to determine a middle of a flare peak associated with the one or more plants 102 that occurred in the first time period. Said differently, for example, performing the second peak prediction operation includes flare peak prediction system 140 being configured to perform a multiclass classification technique to determine one or more flare peaks associated with the one or more plants 102 that occurred during the first time period by determining the start, middle, and end of a flare peak (e.g., using historical flaring data representative of a rate of flaring).

In some embodiments, the plurality of peak prediction operations includes a third peak prediction operation. In some embodiments, the third peak prediction operation includes the flare peak prediction system 140 being configured to perform a regression technique using historical flaring data. In some embodiments, the flare peak prediction system 140 is configured to perform a third peak prediction operation when historical flaring data identified by the flare peak prediction system 140 is not representative and/or indicative of a rate of flaring associated with the one or more plants 102 during the first time period. In some embodiments, a regression technique includes the flare peak prediction system 140 being configured to use historical flaring data to determine a predicted flaring rate associated with the one or more plants 102 that occurred in the first time period.

In some embodiments, the third peak prediction operation includes the flare peak prediction system 140 being configured to perform one or more optimization techniques using a predicted flare rate. For example, the third peak prediction operation of the plurality of peak prediction operations may include performing one or more optimization techniques using a predicted flaring rate determined by performing a regression technique using historical flaring data. In some embodiments, the one or more optimization techniques include the flare peak prediction system 140 being configured to perform one or more of a binary classification technique, a multiclass classification technique, a random forest technique, a neural network-based technique, and/or the like using a predicted flaring rate determined using a regression technique to determine one or more flare peaks. Said differently, for example, the third peak prediction operation may include the flare peak prediction system 140 being configured to use a regression technique to determine a predicted flaring rate and then perform one or more optimization techniques using the determined predicted flaring rate.

In some embodiments, the plurality of peak prediction operations includes a fourth peak prediction operation. In some embodiments, the fourth peak prediction operation includes the flare peak prediction system 140 being configured to perform a multivariate time series forecasting technique using historical flaring data. In some embodiments, the flare peak prediction system 140 is configured to perform a fourth peak prediction operation when historical flaring data identified by the flare peak prediction system 140 is not representative and/or indicative of a rate of flaring associated with the one or more plants 102 during the first time period. In some embodiments, a multivariate time series forecasting technique includes the flare peak prediction system 140 being configured to use historical flaring data to determine a predicted flaring rate associated with the one or more plants 102 that occurred in the first time period.

In some embodiments, the fourth peak prediction operation includes the flare peak prediction system 140 being configured to perform one or more optimization techniques using a predicted flare rate. For example, the fourth peak prediction operation of the plurality of peak prediction operations may include performing one or more optimization techniques using a predicted flaring rate determined by performing a multivariate time series forecasting technique using historical flaring data. In some embodiments, the one or more optimization techniques include the flare peak prediction system 140 being configured to perform one or more of a binary classification technique, a multiclass classification technique, a random forest technique, a neural network-based technique, and/or the like using a predicted flaring rate determined using a multivariate time series forecasting technique to determine one or more flare peaks. Said differently, for example, the fourth peak prediction operation may include the flare peak prediction system 140 being configured to use a multivariate time series forecasting technique to determine a predicted flaring rate and then perform one or more optimization techniques using the determined predicted flaring rate.

In some embodiments, configuring the flare peak prediction model includes the flare peak prediction system 140 being configured to generate flare peak signature data. In some embodiments, flare peak signature data includes one or more items of data representative and/or indicative of operations of one or more components of the one or more plants 102 that are indicative of causing the one or more flare peaks associated with the one or more plants 102 that occurred during the first time period (e.g., the one or more flare peaks that were determined by the flare peak prediction system 140 by performing at least one of the plurality of peak prediction operations). For example, flare peak signature data may include one or more items of data representative and/or indicative of operations of one or more valve components that caused the one or more flare peaks associated with the one or more plants 102 that occurred during the first time period.

In some embodiments, the flare peak prediction system 140 is configured to generate flare peak signature data based on the one or more flare peaks (e.g., the one or more flare peaks that were determined by the flare peak prediction system 140 by performing at least one of the plurality of peak prediction operations) and/or historical plant component operations data. In this regard, in some embodiments, generating flare peak signature data includes the flare peak prediction system 140 being configured to perform a root cause analysis. In this regard, in some embodiments, performing a root cause analysis includes the flare peak prediction system 140 being configured to use historical plant component operations data to identify one or more components of the one or more plants 102 that were operating outside of a normal operating range before and/or during a flare peak that occurred in the first time period. For example, the flare peak prediction system 140 may be configured to use historical plant component operations data to identify one or more valve components that were operating outside of a normal operating range before and/or during a flare peak that occurred in the first time period. Said differently, for example, by using historical plant component operations data to identify components of the one or more plants 102 that were operating outside of a normal operating range before and/or during a flare peak during the time period when there flare peaks, the flare peak prediction system 140 may be able to identify operations of one or more components of the one or more plants 102 that are indicative of causing the one or more flare peaks.

In some embodiments, configuring the flare peak prediction model includes the flare peak prediction system 140 being configured to train the flare peak prediction model. In some embodiments, the flare peak prediction system 140 is configured to train the flare peak prediction model using flare peak signature data. In this regard, in some embodiments, training the flare peak prediction model includes the flare peak prediction system 140 being configured to train the flare peak prediction model to recognize operations of one or more components of the first plant and/or one or more other plants in the one or more plants 102 that that may cause a flare peak. For example, training the flare peak prediction model includes the flare peak prediction system 140 being configured to train the flare peak prediction model to analyze real-time plant operations data associated with the first plant to recognize operations of one or more components of the first plant that may cause a flare peak, such that a flare peak can be prevented or mitigated.

In some embodiments, the flare peak prediction system 140 is configured to receive real-time plant operations data. In some embodiments, the flare peak prediction system 140 is configured to receive real-time plant operations data from the one or more plants 102, the user device 160, and/or the one or more sensors 120. For example, the flare peak prediction system 140 is configured to receive real-time plant operations data from the first plant of the one or more plants 102. In some embodiments, real-time plant operations data includes one or more items of data representative and/or indicative of real-time flaring performed by the one or more plants 102. For example, real-time plant operations data includes one or more items of data representative and/or indicative of real-time flaring performed by the first plant of the one or more plants 102. Additionally, or alternatively, real-time plant operations data includes one or more items of data representative and/or indicative of real-time operations of one or more components of the one or more plants 102. For example, real-time plant operations data includes one or more items of data representative and/or indicative of real-time operations of one or more components of the first plant of the one or more plants 102.

In some embodiments, the flare peak prediction system 140 is configured to generate flare peak prediction data. In some embodiments, flare peak prediction data includes one or more items of data representative and/or indicative of an upcoming flare peak at the first plant and/or one or more other plants in the one or more plants 102. For example, flare peak prediction data may include one or more items of data representative of an indication that a flare peak will occur at the first plant in the next hour. Said differently, for example, flare peak prediction data may be representative of a prediction that a flare peak will occur at the first plant.

In some embodiments, the flare peak prediction system 140 is configured to generate flare peak prediction data by applying real-time plant operations data to the flare peak prediction model. In some embodiments, the flare peak prediction system 140 is configured to apply real-time plant operations data to the flare peak prediction model after the flare peak prediction system 140 has configured. In this regard, for example, by configuring the flare peak prediction model to recognize operations of one or more components of the first plant (e.g., based on training using flare peak signature data) that that may cause a flare peak, the flare peak prediction system 140 may be able to use the flare peak prediction model to generate flare peak prediction data. In this regard, for example, the flare peak prediction system 140 may be able to use the flare peak prediction model to generate flare peak prediction data because the flare peak prediction model is able to analyze real-time plant operations data associated with the first plant to recognize operations of one or more components of the first plant that may cause a flare peak.

In some embodiments, the flare peak prediction model is a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate flare peak prediction data. In this regard, in some embodiments, the flare peak prediction model may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, generative artificial intelligence techniques, filtration techniques, grouping techniques, sorting techniques, trend techniques, correlation techniques, clustering techniques, and/or the like. For example, the flare peak prediction model may use any of the above techniques to analyze real-time plant operations data associated with the first plant to generate flare peak prediction data.

In some embodiments, the flare peak prediction system 140 is configured to initiate performance of one or more flare peak prediction responsive actions. In some embodiments, the flare peak prediction system 140 is configured to initiate performance of one or more flare peak prediction responsive actions based on flare peak prediction data, historical flaring data, historical plant component operations data, real-time plant operations data, and/or the like. In this regard, in some embodiments, initiating performance of one or more flare peak prediction responsive actions includes the flare peak prediction system 140 being configured to generate a flare peak prediction interface component 302.

In some embodiments, the flare peak prediction interface component 302 includes a historical flaring interface element 304. In some embodiments, the historical flaring interface element 304 is configured to display historical flaring data. In this regard, for example, the historical flaring interface element 304 may be configured to display historical flaring data that is representative and/or indicative of one or more flare peaks in the first time period.

In some embodiments, the flare peak prediction interface component 302 includes a historical plant component operations interface element 306. In some embodiments, the historical plant component operations interface element 306 is configured to display historical plant component operations data. In this regard, for example, the historical plant component operations interface element 306 may be configured to display historical plant component operations data that is representative and/or indicative of historical operations of one or more valve components that are associated with the one or more plants 102.

In some embodiments, the flare peak prediction interface component 302 includes a real-time plant operations interface element 308. In some embodiments, the real-time plant operations interface element 308 is configured to display real-time plant operations data. In this regard, for example, the real-time plant operations interface element 308 may be configured to display real-time plant operations data that is representative and/or indicative of real-time flaring performed by the one or more plants 102 and/or real-time operations of one or more components of the one or more plants 102. For example, the real-time plant operations interface element 308 may be configured to display real-time plant operations data that is representative and/or indicative of real-time flaring performed by the first plant and/or real-time operations of one or more components of the first plant (e.g., a valve component of the first plant).

In some embodiments, the flare peak prediction interface component 302 includes a flare peak prediction interface element 310. In some embodiments, the flare peak prediction interface element 310 is configured to display flare peak prediction data. In this regard, for example, the flare peak prediction interface element 310 may be configured to display flare peak prediction data that is representative and/or indicative of an upcoming flare peak at the first plant and/or one or more other plants in the one or more plants 102. For example, the flare peak prediction interface element 310 may be configured to display flare peak prediction data that indicative that there is an upcoming flare peak at the first plant within the next hour. In some embodiments, the flare peak prediction interface component 302 includes a flare peak prevention action instruction interface element 312. In some embodiments, the flare peak prevention action instruction interface element 312 is configured to display a flare peak prevention action instruction.

In some embodiments, initiating performance of one or more flare peak prediction responsive actions includes the flare peak prediction system 140 being configured to cause the flare peak prediction interface component 302 to be rendered to a flare peak prediction interface 300 of a computing device. In some embodiments, the computing device is associated with the one or more plants 102, the flare peak prediction system 140, the user device 160, and/or one or more remote computing devices. In this regard, in some embodiments, the flare peak prediction interface 300 may be provided at the one or more plants 102, the flare peak prediction system 140, the user device 160, and/or one or more remote computing devices.

In some embodiments, initiating performance of one or more flare peak prediction responsive actions includes the flare peak prediction system 140 being configured to cause actuation of at least one component of the first plant and/or one or more other plants of the one or more plants 102. For example, the flare peak prediction system 140 may be configured to cause actuation of at least one of one or more valve components that are associated with the first plant. In this regard, for example, by causing actuation of at least one of one or more valve components that are associated with the first plant the flare peak prediction system 140 may be configured to prevent and/or mitigate an upcoming or ongoing flare peak associated with the first plant.

In some embodiments, initiating performance of one or more flare peak prediction responsive actions includes the flare peak prediction system 140 being configured to transmit a flare peak prevention action instruction to the first plant, one or more other plants of the one or more plants 102, and/or the user device 160. In some embodiments, a flare peak prevention action instruction includes one or more items of data that are representative and/or indicative of instructions for adjusting operations of the first plant and/or one or more other plants of the one or more plants 102 to prevent and/or mitigate an upcoming or ongoing flare peak. For example, a flare peak prevention action instruction includes one or more items of data that are representative and/or indicative of instructions for adjusting a valve component of the first plant to prevent and/or mitigate an upcoming or ongoing flare peak at the first plant.

### Example Methods

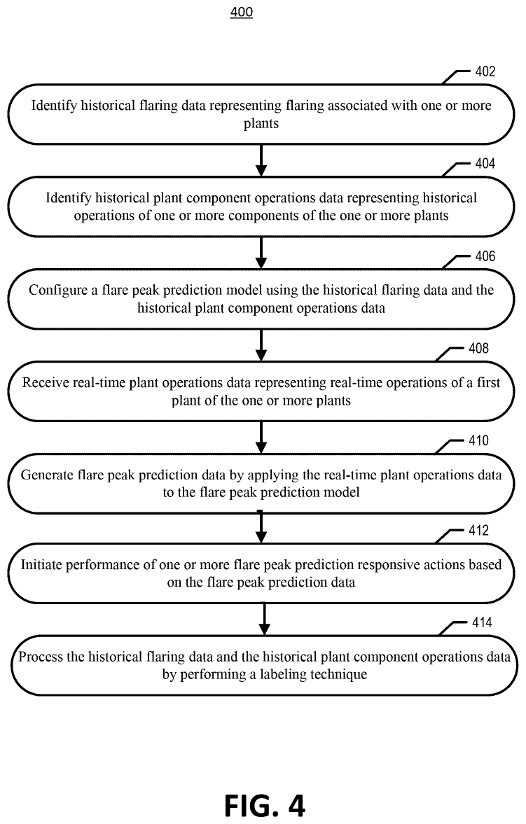

Referring now to FIG. 4, a flowchart providing an example method 400 is illustrated. In this regard, FIG. 4 illustrates operations that may be performed by the flare peak prediction system 140, the user device 160, the one or more plants 102, and/or the like. In some embodiments, the method 400 includes operations for generating flare peak prediction data and/or initiating performance of one or more flare peak prediction responsive actions. In some embodiments, the example method 400 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 400.

As shown in block 402, the method 400 may include identifying historical flaring data representing flaring associated with one or more plants. As described above, in some embodiments, historical flaring data includes one or more items of data representative of historical flaring performed by the one or more plants. In some embodiments, historical flaring data is associated with a first time period. In some embodiments, the first time period is a timeboxed period, time interval, and/or unit of time that previously occurred (e.g., a period of time that has elapsed, a historical period of time, etc.). In this regard, for example, historical flaring data may be representative and/or indicative of a historical rate of flaring performed by the one or more plants in the first time period. As another example, historical flaring data may be representative and/or indicative of an amount of flaring in the first time period (e.g., the total amount of flaring performed in the first time period). As another example, historical flaring data may be representative and/or indicative of a duration of flaring in the first time period (e.g., how long flaring events in the first time period lasted). As another example, historical flaring data may be representative and/or indicative of content of flaring in the first time period (e.g., what types of gases were released and/or burned during the flaring). As another example, historical flaring data may be representative and/or indicative of one or more flare peaks in the first time period.

In some embodiments, a flare peak is representative and/or indicative of a temporary increase in flaring performed by the one or more plants relative to a baseline flaring rate (e.g., an increase in a rate or an amount of flaring). For example, if the one or more plants are flaring at a rate of one thousand cubic feet per day, a flare peak may be when the flaring rate is at ten thousand cubic feet per day. In this regard, for example, historical flaring data may be representative and/or indicative of content of a flare peak that occurred in the first time period (e.g., what types of gases were released and/or burned during a flare peak). As another example, historical flaring data may be representative and/or indicative of a duration of a flare peak that occurred in the first time period. As another example, historical flaring data be representative and/or indicative of the start of a flare peak that occurred in the first time period. As another example, historical flaring data be representative and/or indicative of the middle of a flare peak that occurred in the first time period (e.g., a halfway point of the flare peak). As another example, historical flaring data be representative and/or indicative of the end of a flare peak that occurred in the first time period. As another example, historical flaring data may be representative and/or indicative of an amount above a baseline flaring rate that a flare peak was during the first time period.

In some embodiments, identifying historical flaring data includes the flare peak prediction system being configured to receive historical flaring data. For example, the flare peak prediction system may be configured to receive historical flaring data from the one or more plants (e.g., such as the first plant in the one or more plants), the user device, and/or the one or more sensors. In some embodiments, prior to receiving historical flaring data, the flare peak prediction system is configured to cause the one or more plants and/or the one or more sensors to generate and/or capture the historical flaring data. Additionally, or alternatively, identifying historical flaring data includes the flare peak prediction system being configured to generate historical flaring data. For example, the flare peak prediction system may be configured to generate historical flaring data using other data associated with the one or more plants. In this regard, for example, the flare peak prediction system may be configured to generate historical flaring data using historical plant component operations data associated with the one or more plants. Additionally, or alternatively, identifying historical flaring data may include the flare peak prediction system being configured to generate at least a portion of historical flaring data. For example, the flare peak prediction system may be configured to receive a first portion of historical flaring data and, using the first portion, generate a second portion of historical flaring data (e.g., using interpolation).

As shown in block 404, the method 400 may include identifying historical plant component operations data representing historical operations of one or more components of the one or more plants. As described above, in some embodiments, the historical plant component operations data is associated with the first time period. In some embodiments, historical plant component operations data includes one or more items of data representative and/or indicative of historical operations of one or more components of the one or more plants. For example, historical plant component operations data may be representative and/or indicative of the historical operations of one or more valve components that are associated with the one or more plants (e.g., during the first time period).

In some embodiments, identifying historical plant component operations data includes the flare peak prediction system being configured to receive historical plant component operations data. For example, the flare peak prediction system may be configured to receive historical plant component operations data from the one or more plants (e.g., such as the first plant in the one or more plants), the user device, and/or the one or more sensors. In some embodiments, prior to receiving historical plant component operations data, the flare peak prediction system is configured to cause the one or more plants and/or the one or more sensors to generate and/or capture the historical plant component operations data. Additionally, or alternatively, identifying historical plant component operations data includes the flare peak prediction system being configured to generate historical plant component operations data. For example, the flare peak prediction system may be configured to generate historical plant component operations data using other data associated with the one or more plants. In this regard, for example, the flare peak prediction system may be configured to generate historical plant component operations data using historical flaring data associated with the one or more plants. Additionally, or alternatively, identifying historical plant component operations data may include the flare peak prediction system being configured to generate at least a portion of historical plant component operations data. For example, the flare peak prediction system may be configured to receive a first portion of historical plant component operations data and, using the first portion, generate a second portion of historical plant component operations data (e.g., using interpolation).

As shown in block 406, the method 400 may include configuring a flare peak prediction model using the historical flaring data and the historical plant component operations data. As described above, in some embodiments, configured to configure the flare peak prediction model using historical flaring data (e.g., using historical flaring data identified by the flare peak prediction system). Additionally, or alternatively, the flare peak prediction system is configured to configure the flare peak prediction model using historical plant component operations data (e.g., using historical plant component operations data identified by the flare peak prediction system).

As shown in block 408, the method 400 may include receiving real-time plant operations data representing real-time operations of a first plant of the one or more plants. As described above, in some embodiments, the flare peak prediction system is configured to receive real-time plant operations data from the one or more plants, the user device, and/or the one or more sensors. For example, the flare peak prediction system is configured to receive real-time plant operations data from the first plant of the one or more plants. In some embodiments, real-time plant operations data includes one or more items of data representative and/or indicative of real-time flaring performed by the one or more plants. For example, real-time plant operations data includes one or more items of data representative and/or indicative of real-time flaring performed by the first plant of the one or more plants. Additionally, or alternatively, real-time plant operations data includes one or more items of data representative and/or indicative of real-time operations of one or more components of the one or more plants. For example, real-time plant operations data includes one or more items of data representative and/or indicative of real-time operations of one or more components of the first plant of the one or more plants.

As shown in block 410, the method 400 may include generating flare peak prediction data by applying the real-time plant operations data to the flare peak prediction model. As described above, in some embodiments, flare peak prediction data includes one or more items of data representative and/or indicative of an upcoming flare peak at the first plant and/or one or more other plants in the one or more plants. For example, flare peak prediction data may include one or more items of data representative of an indication that a flare peak will occur at the first plant in the next hour. Said differently, for example, flare peak prediction data may be representative of a prediction that a flare peak will occur at the first plant.

In some embodiments, the flare peak prediction system is configured to generate flare peak prediction data by applying real-time plant operations data to the flare peak prediction model. In some embodiments, the flare peak prediction system is configured to apply real-time plant operations data to the flare peak prediction model after the flare peak prediction system has configured. In this regard, for example, by configuring the flare peak prediction model to recognize operations of one or more components of the first plant (e.g., based on training using flare peak signature data) that that may cause a flare peak, the flare peak prediction system may be able to use the flare peak prediction model to generate flare peak prediction data. In this regard, for example, the flare peak prediction system may be able to use the flare peak prediction model to generate flare peak prediction data because the flare peak prediction model is able to analyze real-time plant operations data associated with the first plant to recognize operations of one or more components of the first plant that may cause a flare peak.

In some embodiments, the flare peak prediction model is a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate flare peak prediction data. In this regard, in some embodiments, the flare peak prediction model may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, generative artificial intelligence techniques, filtration techniques, grouping techniques, sorting techniques, trend techniques, correlation techniques, clustering techniques, and/or the like. For example, the flare peak prediction model may use any of the above techniques to analyze real-time plant operations data associated with the first plant to generate flare peak prediction data.

As shown in block 412, the method 400 may include initiating performance of one or more flare peak prediction responsive actions based on the flare peak prediction data. As described above, in some embodiments, the flare peak prediction system is configured to initiate performance of one or more flare peak prediction responsive actions based on flare peak prediction data, historical flaring data, historical plant component operations data, real-time plant operations data, and/or the like.

As shown in block 414, the method 400 may include processing the historical flaring data and the historical plant component operations data by performing a labeling technique. As described above, in some embodiments, processing historical flaring data includes performing a labeling technique. In this regard, for example, processing historical flaring data by performing a labeling technique includes the flare peak prediction system being configured to tag historical flaring data with one or more information labels that describe the historical flaring data. In some embodiments, the flare peak prediction system is configured to process historical plant component operations data. In some embodiments, processing historical plant component operations data includes performing a labeling technique. In this regard, for example, processing historical plant component operations data by performing a labeling technique includes the flare peak prediction system being configured to tag historical plant component operations data with one or more information labels that describe the historical plant component operations data.

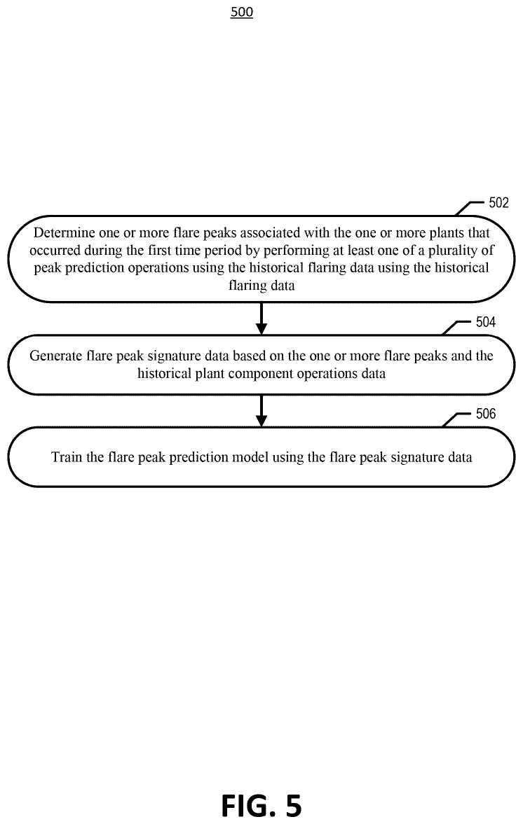

Referring now to FIG. 5, a flowchart providing an example method 500 is illustrated. In this regard, FIG. 5 illustrates operations that may be performed by the flare peak prediction system 140, the user device 160, the one or more plants 102, and/or the like. In some embodiments, the method 500 includes operations for configuring a flare peak prediction model. In some embodiments, the example method 500 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500.

As shown in block 502, the method 500 may include determining one or more flare peaks associated with the one or more plants that occurred during the first time period by performing at least one of a plurality of peak prediction operations using the historical flaring data using the historical flaring data. As described above, in some embodiments, the flare peak prediction system is configured to determine one or more flare peaks associated with the one or more plants during the first time period by performing at least one of a plurality of peak prediction operations. In some embodiments, the flare peak prediction system is configured to performing at least one of a plurality of peak prediction operations using historical flaring data. In this regard, for example, the flare peak prediction system may be configured to determine one or more flare peaks that occurred at the one or more plants during the first time period (e.g., the time period associated with historical flaring data identified by the flare peak prediction system and/or historical operations data). Said differently, for example, the flare peak prediction system may be configured to perform multiple different operations and/or techniques to determine one or more flare peaks.

As shown in block 504, the method 500 may include generating flare peak signature data based on the one or more flare peaks and the historical plant component operations data. As described above, in some embodiments, flare peak signature data includes one or more items of data representative and/or indicative of operations of one or more components of the one or more plants that are indicative of causing the one or more flare peaks associated with the one or more plants that occurred during the first time period (e.g., the one or more flare peaks that were determined by the flare peak prediction system by performing at least one of the plurality of peak prediction operations). For example, flare peak signature data may include one or more items of data representative and/or indicative of operations of one or more valve components that caused the one or more flare peaks associated with the one or more plants that occurred during the first time period.

In some embodiments, the flare peak prediction system is configured to generate flare peak signature data based on the one or more flare peaks (e.g., the one or more flare peaks that were determined by the flare peak prediction system by performing at least one of the plurality of peak prediction operations) and/or historical plant component operations data. In this regard, in some embodiments, generating flare peak signature data includes the flare peak prediction system being configured to perform a root cause analysis. In this regard, in some embodiments, performing a root cause analysis includes the flare peak prediction system being configured to use historical plant component operations data to identify one or more components of the one or more plants that were operating outside of a normal operating range before and/or during a flare peak that occurred in the first time period. For example, the flare peak prediction system may be configured to use historical plant component operations data to identify one or more valve components that were operating outside of a normal operating range before and/or during a flare peak that occurred in the first time period. Said differently, for example, by using historical plant component operations data to identify components of the one or more plants that were operating outside of a normal operating range before and/or during a flare peak during the time period when there flare peaks, the flare peak prediction system may be able to identify operations of one or more components of the one or more plants that are indicative of causing the one or more flare peaks.

As shown in block 506, the method 500 may include training the flare peak prediction model using the flare peak signature data. As described above, in some embodiments, the flare peak prediction system is configured to train the flare peak prediction model using flare peak signature data. In this regard, in some embodiments, training the flare peak prediction model includes the flare peak prediction system being configured to train the flare peak prediction model to recognize operations of one or more components of the first plant and/or one or more other plants in the one or more plants that that may cause a flare peak. For example, training the flare peak prediction model includes the flare peak prediction system being configured to train the flare peak prediction model to analyze real-time plant operations data associated with the first plant to recognize operations of one or more components of the first plant that may cause a flare peak, such that a flare peak can be prevented or mitigated.

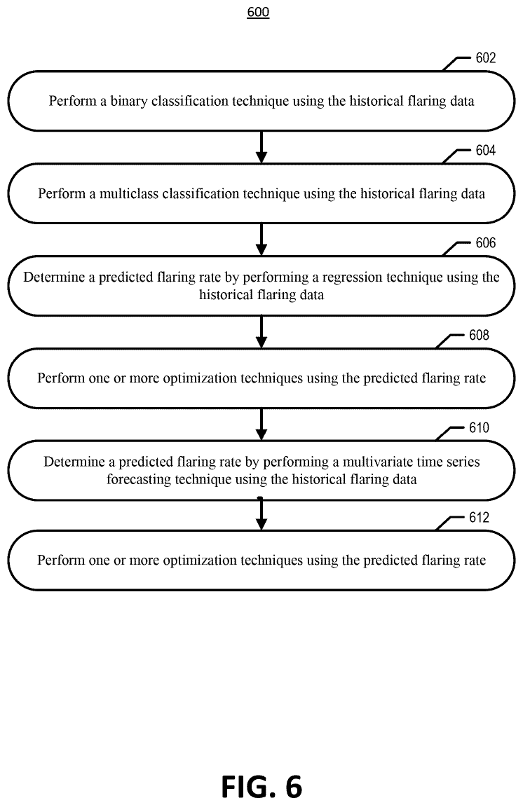

Referring now to FIG. 6, a flowchart providing an example method 600 is illustrated. In this regard, FIG. 6 illustrates operations that may be performed by the flare peak prediction system 140, the user device 160, the one or more plants 102, and/or the like. In some embodiments, the method 600 includes operations for performing one or more of a plurality of peak prediction operations. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As shown in block 602, the method 600 may include performing a binary classification technique using the historical flaring data. As described above, in some embodiments, the first peak prediction operation includes the flare peak prediction system being configured to perform a binary classification technique using historical flaring data. In some embodiments, a binary classification technique includes the flare peak prediction system being configured to use historical flaring data that is representative and/or indicative of a rate of flaring to determine whether there is a flare peak associated with the one or more plants (e.g., yes, there is a flare peak) that occurred in the first time period. Additionally, or alternatively, a binary classification technique includes the flare peak prediction system being configured to use historical flaring data that is representative and/or indicative of a rate of flaring to determine whether there is not a flare peak associated with the one or more plants that occurred in the first time period (e.g., no, there is not a flare peak). Said differently, for example, performing the first peak prediction operation includes flare peak prediction system being configured to perform a binary classification technique to determine one or more flare peaks associated with the one or more plants that occurred during the first time period by determining whether there is a flare peak or whether there is not a flare peak (e.g. using historical flaring data representative of a rate of flaring).

As shown in block 604, the method 600 may include performing a multiclass classification technique using the historical flaring data. As described above, in some embodiments, the second peak prediction operation includes the flare peak prediction system being configured to perform a multiclass classification technique using historical flaring data. In some embodiments, a multiclass classification technique includes the flare peak prediction system being configured to use historical flaring data that is representative and/or indicative of a rate of flaring to determine a start of a flare peak associated with the one or more plants that occurred in the first time period. Additionally, or alternatively, a multiclass classification technique includes the flare peak prediction system being configured to use historical flaring data that is representative and/or indicative of a rate of flaring to determine a middle of a flare peak associated with the one or more plants that occurred in the first time period. Additionally, or alternatively, a multiclass classification technique includes the flare peak prediction system being configured to use historical flaring data that is representative and/or indicative of a rate of flaring to determine a middle of a flare peak associated with the one or more plants that occurred in the first time period. Said differently, for example, performing the second peak prediction operation includes flare peak prediction system being configured to perform a multiclass classification technique to determine one or more flare peaks associated with the one or more plants that occurred during the first time period by determining the start, middle, and end of a flare peak (e.g., using historical flaring data representative of a rate of flaring).

As shown in block 606, the method 600 may include determining a predicted flaring rate by performing a regression technique using the historical flaring data. As described above, in some embodiments, the third peak prediction operation includes the flare peak prediction system being configured to perform a regression technique using historical flaring data. In some embodiments, the flare peak prediction system is configured to perform a third peak prediction operation when historical flaring data identified by the flare peak prediction system is not representative and/or indicative of a rate of flaring associated with the one or more plants during the first time period. In some embodiments, a regression technique includes the flare peak prediction system being configured to use historical flaring data to determine a predicted flaring rate associated with the one or more plants that occurred in the first time period.

As shown in block 608, the method 600 may include performing one or more optimization techniques using the predicted flaring rate. As described above, in some embodiments, the third peak prediction operation includes the flare peak prediction system being configured to perform one or more optimization techniques using a predicted flare rate. For example, the third peak prediction operation of the plurality of peak prediction operations may include performing one or more optimization techniques using a predicted flaring rate determined by performing a regression technique using historical flaring data. In some embodiments, the one or more optimization techniques include the flare peak prediction system being configured to perform one or more of a binary classification technique, a multiclass classification technique, a random forest technique, a neural network-based technique, and/or the like using a predicted flaring rate determined using a regression technique to determine one or more flare peaks. Said differently, for example, the third peak prediction operation may include the flare peak prediction system being configured to use a regression technique to determine a predicted flaring rate and then perform one or more optimization techniques using the determined predicted flaring rate.

As shown in block 610, the method 600 may include determining a predicted flaring rate by performing a multivariate time series forecasting technique using the historical flaring data. As described above, in some embodiments, the fourth peak prediction operation includes the flare peak prediction system being configured to perform a multivariate time series forecasting technique using historical flaring data. In some embodiments, the flare peak prediction system is configured to perform a fourth peak prediction operation when historical flaring data identified by the flare peak prediction system is not representative and/or indicative of a rate of flaring associated with the one or more plants during the first time period. In some embodiments, a multivariate time series forecasting technique includes the flare peak prediction system being configured to use historical flaring data to determine a predicted flaring rate associated with the one or more plants that occurred in the first time period.

As shown in block 612, the method 600 may include performing one or more optimization techniques using the predicted flaring rate. As described above, in some embodiments, the fourth peak prediction operation includes the flare peak prediction system being configured to perform one or more optimization techniques using a predicted flare rate. For example, the fourth peak prediction operation of the plurality of peak prediction operations may include performing one or more optimization techniques using a predicted flaring rate determined by performing a multivariate time series forecasting technique using historical flaring data. In some embodiments, the one or more optimization techniques include the flare peak prediction system being configured to perform one or more of a binary classification technique, a multiclass classification technique, a random forest technique, a neural network-based technique, and/or the like using a predicted flaring rate determined using a multivariate time series forecasting technique to determine one or more flare peaks. Said differently, for example, the fourth peak prediction operation may include the flare peak prediction system being configured to use a multivariate time series forecasting technique to determine a predicted flaring rate and then perform one or more optimization techniques using the determined predicted flaring rate.

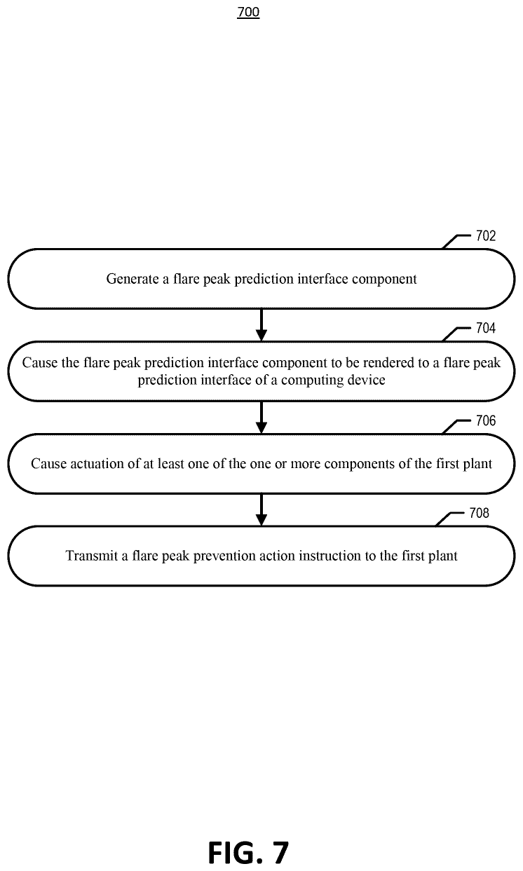

Referring now to FIG. 7, a flowchart providing an example method 700 is illustrated. In this regard, FIG. 7 illustrates operations that may be performed by the flare peak prediction system 140, the user device 160, the one or more plants 102, and/or the like. In some embodiments, the method 700 includes operations for initiating performance of one or more flare peak prediction responsive actions. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 may include generating a flare peak prediction interface component. As described above, in some embodiments, the flare peak prediction interface component includes a historical flaring interface element. In some embodiments, the historical flaring interface element is configured to display historical flaring data. In this regard, for example, the historical flaring interface element may be configured to display historical flaring data that is representative and/or indicative of one or more flare peaks in the first time period.

In some embodiments, the flare peak prediction interface component includes a historical plant component operations interface element. In some embodiments, the historical plant component operations interface element is configured to display historical plant component operations data. In this regard, for example, the historical plant component operations interface element may be configured to display historical plant component operations data that is representative and/or indicative of historical operations of one or more valve components that are associated with the one or more plants.

In some embodiments, the flare peak prediction interface component includes a real-time plant operations interface element. In some embodiments, the real-time plant operations interface element is configured to display real-time plant operations data. In this regard, for example, the real-time plant operations interface element may be configured to display real-time plant operations data that is representative and/or indicative of real-time flaring performed by the one or more plants and/or real-time operations of one or more components of the one or more plants. For example, the real-time plant operations interface element may be configured to display real-time plant operations data that is representative and/or indicative of real-time flaring performed by the first plant and/or real-time operations of one or more components of the first plant (e.g., a valve component of the first plant).

In some embodiments, the flare peak prediction interface component includes a flare peak prediction interface element. In some embodiments, the flare peak prediction interface element is configured to display flare peak prediction data. In this regard, for example, the flare peak prediction interface element may be configured to display flare peak prediction data that is representative and/or indicative of an upcoming flare peak at the first plant and/or one or more other plants in the one or more plants. For example, the flare peak prediction interface element may be configured to display flare peak prediction data that indicative that there is an upcoming flare peak at the first plant within the next hour. In some embodiments, the flare peak prediction interface component includes a flare peak prevention action instruction interface element. In some embodiments, the flare peak prevention action instruction interface element is configured to display a flare peak prevention action instruction.

As shown in block 704, the method 700 may include causing the flare peak prediction interface component to be rendered to a flare peak prediction interface of a computing device. As described above, in some embodiments, the computing device is associated with the one or more plants, the flare peak prediction system, the user device, and/or one or more remote computing devices. In this regard, in some embodiments, the flare peak prediction interface may be provided at the one or more plants, the flare peak prediction system, the user device, and/or one or more remote computing devices.

As shown in block 706, the method 700 may include causing actuation of at least one of the one or more components of the first plant. As described above, in some embodiments, the flare peak prediction system may be configured to cause actuation of at least one of one or more valve components that are associated with the first plant. In this regard, for example, by causing actuation of at least one of one or more valve components that are associated with the first plant the flare peak prediction system may be configured to prevent and/or mitigate an upcoming or ongoing flare peak associated with the first plant.

As shown in block 708, the method 700 may include transmitting a flare peak prevention action instruction to the first plant. As described above, in some embodiments, a flare peak prevention action instruction includes one or more items of data that are representative and/or indicative of instructions for adjusting operations of the first plant and/or one or more other plants of the one or more plants to prevent and/or mitigate an upcoming or ongoing flare peak. For example, a flare peak prevention action instruction includes one or more items of data that are representative and/or indicative of instructions for adjusting a valve component of the first plant to prevent and/or mitigate an upcoming or ongoing flare peak at the first plant.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
identifying historical flaring data representing flaring associated with one or more plants, wherein the historical flaring data is associated with a first time period;
identifying historical plant component operations data representing historical operations of one or more components of the one or more plants, wherein the historical plant component operations data is associated with the first time period;
configuring a flare peak prediction model using the historical flaring data and the historical plant component operations data;
receiving real-time plant operations data representing real-time operations of a first plant of the one or more plants;
generating flare peak prediction data by applying the real-time plant operations data to the flare peak prediction model; and
initiating performance of one or more flare peak prediction responsive actions based on the flare peak prediction data.

2. The method of claim 1, further comprising:
processing the historical flaring data and the historical plant component operations data by performing a labeling technique.

3. The method of claim 1, wherein configuring the flare peak prediction model comprises:
determining one or more flare peaks associated with the one or more plants that occurred during the first time period by performing at least one of a plurality of peak prediction operations using the historical flaring data using the historical flaring data;
generating flare peak signature data based on the one or more flare peaks and the historical plant component operations data; and
training the flare peak prediction model using the flare peak signature data.

4. The method of claim 3, wherein a first peak prediction operation of the plurality of peak prediction operations comprises:
performing a binary classification technique using the historical flaring data.

5. The method of claim 3, wherein a second peak prediction operation of the plurality of peak prediction operations comprises:
performing a multiclass classification technique using the historical flaring data.

6. The method of claim 3, wherein a third peak prediction operation of the plurality of peak prediction operations comprises:
determining a predicted flaring rate by performing a regression technique using the historical flaring data; and
performing one or more optimization techniques using the predicted flaring rate.

7. The method of claim 3, wherein a fourth peak prediction operation of the plurality of peak prediction operations comprises:
determining a predicted flaring rate by performing a multivariate time series forecasting technique using the historical flaring data; and
performing one or more optimization techniques using the predicted flaring rate.

8. The method of claim 1, wherein initiating performance of the one or more flare peak prediction responsive actions comprises:
generating a flare peak prediction interface component, wherein the flare peak prediction interface component comprises the flare peak prediction data; and
causing the flare peak prediction interface component to be rendered to a flare peak prediction interface of a computing device.

9. The method of claim 1, wherein initiating performance of the one or more flare peak prediction responsive actions comprises:
causing actuation of at least one of the one or more components of the first plant.

10. The method of claim 1, wherein initiating performance of the one or more flare peak prediction responsive actions comprises:
transmitting a flare peak prevention action instruction to the first plant.

11. An apparatus comprising memory and one or more processors communicatively coupled to the memory, the one or more processors configured to:
identify historical flaring data representing flaring associated with one or more plants, wherein the historical flaring data is associated with a first time period;
identify historical plant component operations data representing historical operations of one or more components of the one or more plants, wherein the historical plant component operations data is associated with the first time period;
configure a flare peak prediction model using the historical flaring data and the historical plant component operations data;
receive real-time plant operations data representing real-time operations of a first plant of the one or more plants;
generate flare peak prediction data by applying the real-time plant operations data to the flare peak prediction model; and
initiate performance of one or more flare peak prediction responsive actions based on the flare peak prediction data.

12. The apparatus of claim 11, wherein to configure the flare peak prediction model comprises the one or more processors being configured to:
determine one or more flare peaks associated with the one or more plants that occurred during the first time period by performing at least one of a plurality of peak prediction operations using the historical flaring data using the historical flaring data;
generate flare peak signature data based on the one or more flare peaks and the historical plant component operations data; and
train the flare peak prediction model using the flare peak signature data.

13. The apparatus of claim 12, wherein a first peak prediction operation of the plurality of peak prediction operations comprises the one or more processors being configured to:
perform a binary classification technique using the historical flaring data.

14. The apparatus of claim 12, wherein a second peak prediction operation of the plurality of peak prediction operations comprises the one or more processors being configured to:
perform a multiclass classification technique using the historical flaring data.

15. The apparatus of claim 12, wherein a third peak prediction operation of the plurality of peak prediction operations comprises the one or more processors being configured to:
determine a predicted flaring rate by performing a regression technique using the historical flaring data; and
perform one or more optimization techniques using the predicted flaring rate.

16. The apparatus of claim 12, wherein a fourth peak prediction operation of the plurality of peak prediction operations comprises the one or more processors being configured to:
determine a predicted flaring rate by performing a multivariate time series forecasting technique using the historical flaring data; and
performing one or more optimization techniques using the predicted flaring rate.

17. The apparatus of claim 11, wherein to initiate performance of the one or more flare peak prediction responsive actions comprises the one or more processors being configured to:
generate a flare peak prediction interface component, wherein the flare peak prediction interface component comprises the flare peak prediction data; and
cause the flare peak prediction interface component to be rendered to a flare peak prediction interface of a computing device.

18. The apparatus of claim 11, wherein to initiate performance of the one or more flare peak prediction responsive actions comprises the one or more processors being configured to:
cause actuation of at least one of the one or more components of the first plant.

19. The apparatus of claim 11, wherein to initiate performance of the one or more flare peak prediction responsive actions comprises the one or more processors being configured to:
transmit a flare peak prevention action instruction to the first plant.

20. A computer program product comprising at least one non-transitory computer-readable storage medium having computer program code stored thereon that, in execution with at least one processor, configures the computer program product for:
identifying historical flaring data representing flaring associated with one or more plants, wherein the historical flaring data is associated with a first time period;
identifying historical plant component operations data representing historical operations of one or more components of the one or more plants, wherein the historical plant component operations data is associated with the first time period;
configuring a flare peak prediction model using the historical flaring data and the historical plant component operations data;
receiving real-time plant operations data representing real-time operations of a first plant of the one or more plants;
generating flare peak prediction data by applying the real-time plant operations data to the flare peak prediction model; and
initiating performance of one or more flare peak prediction responsive actions based on the flare peak prediction data.
